(19) United States
(12) Patent Application Publication
(10) Pub. No.: US 2024/0179287 A1
(43) Pub. Date: May 30, 2024

(54) APPARATUS AND METHOD WITH DEPTH ESTIMATION

(71) Applicant: Samsung Electronics Co., Ltd., Suwon-si (KR)

(72) Inventors: Weiming LI, Beijing (CN); Namseop KWON, Suwon-si (KR); Bao HE, Beijing (CN); Kyungboo JUNG, Suwon-si (KR); Myungjae JEON, Suwon-si (KR); Qiang WANG, Beijing (CN); Young Hun SUNG, Suwon-si (KR); Lin MA, Beijing (CN)

(73) Assignee: Samsung Electronics Co., Ltd., Suwon-si (KR)

(21) Appl. No.: 18/519,274

(22) Filed: Nov. 27, 2023

(30) Foreign Application Priority Data
Nov. 25, 2022 (CN) 202211512704.8
Oct. 12, 2023 (KR) 10-2023-0135973

(51) Int. Cl. H04N 13/271; G06T 7/00; G06T 7/593

(52) U.S. Cl. CPC H04N 13/271; G06T 7/593; G06T 7/97; G06T 2207/10028; G06T 2207/20084

(57) ABSTRACT

An apparatus and method with depth estimation are disclosed. The method includes calculating a first reliability of each of a plurality of time of flight (ToF) pixels of a ToF image; and generating, based on the first reliabilities, a depth map of a scene based on a left image and a right image and selectively based on the ToF image.

### CROSS-REFERENCE TO RELATED APPLICATIONS

This application claims the benefit under 35 USC § 119(a) of Chinese Patent Application No. 202211512704.8 filed on Nov. 25, 2022, in the China National Intellectual Property Administration, and Korean Patent Application No. 10-2023-0135973 filed on Oct. 12, 2023, in the Korean Intellectual Property Office, the entire disclosures of which are incorporated herein by reference for all purposes.

### BACKGROUND

### 1. Field

The following description relates to a method and apparatus with depth estimation.

### 2. Description of Related Art

Efficient depth estimation may play an important role in an augmented reality (AR) system. Various follow-up tasks may also be supported by analyzing an input sensor image and inferring depth information of a surrounding scene, e.g., to create realistic and immersive AR experiences.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The purpose of the present disclosure is to provide an apparatus and method with depth estimation.

In one general aspect, a processor-implemented method of estimating depth includes calculating a first reliability of each of a plurality of time of flight (ToF) pixels of a ToF image; and generating, based on the first reliabilities, a depth map of a scene based on a left image and a right image and selectively based on the ToF image.

The calculating of the first reliabilities may include projecting each of the plurality of ToF pixels onto the left image and the right image; calculating a second reliability of a respective second ToF pixel, of the plurality of ToF pixels, corresponding to each second ToF projection point on a second corresponding scan line in a first direction; and calculating, based on the calculating of the second reliability, the first reliability of a respective first ToF pixel, of the plurality of ToF pixels, corresponding to each first ToF projection point on a first corresponding scan line in a second direction that is opposite to the first direction.

The calculating of the second reliabilities and the calculating of the first reliabilities may be based on an image feature difference of each second ToF projection point of the left image and the right image and a third reliability of a ToF pixel corresponding to a ToF projection point determined similar to an image feature in which a distance between each second ToF projection point is in a preset range on the second corresponding scan line.

The generating of the depth map may include determine a first quantity of first reliability ToF pixels, of the plurality of ToF pixels, that have respective first reliabilities that satisfy a predetermined requirement; selecting, in response to the first quantity satisfying a first threshold requirement, to generate the depth map based on the ToF image; and selecting, in response to the first quantity not satisfying the first threshold requirement, to generate the depth map without consideration of the ToF image.

The generating of the depth map based on the ToF image may include performing a first stereo matching of the left image and the right image, including a determination of first matched ToF pixels; predicting, using a first neural network, a fourth reliability of each of the plurality of ToF pixels based on the ToF image and a result of the first stereo matching; and generating a first depth map of the scene by performing a second stereo matching of the left image and the right image based on the ToF image and the fourth reliabilities.

The selecting, to generate the depth map based on the ToF image, may be based on the first reliabilities and the ToF image in response to a second quantity of second ToF pixels, of the plurality of ToF pixels, that have respective first reliabilities that satisfy the first threshold requirement and a second threshold requirement; or wherein the selecting, to generate the depth map without the consideration of the ToF image, is based on a third quantity of third ToF pixels, of the plurality of ToF pixels that have respective first reliabilities that satisfy the first threshold requirement and do not satisfy the second threshold requirement.

The predicting of the fourth reliabilities may include predicting the fourth reliabilities using at least one piece of information among first information, second information, and third information as an input to the first neural network, wherein the first information is a difference between a disparity value corresponding to each of the plurality of ToF pixels and a disparity value of each of first matched ToF pixels, wherein the second information is an image feature difference of each of the plurality of ToF pixels of a corresponding projection point of the left image and the right image, and wherein the third information is a difference of depth values between the corresponding projection points and at least one ToF projection point having a determined similar feature in a corresponding projection point area.

The generating of the first depth map may include calculating a respective matching cost of a candidate disparity corresponding to each of the plurality of ToF pixels during the second stereo matching based on a respective value of each of the plurality of ToF pixels and the predicted fourth reliabilities of each of the plurality of ToF pixels; determining a respective disparity value corresponding to each of the plurality of ToF pixels based on the respective matching cost; and estimating the first depth map using the determined respective disparity value.

The generating of the depth map may include projecting the ToF image onto the left image and the right image and generating a second depth map by performing an interpolation, based on corresponding image features of the left image and the right image, on a ToF projection point area that satisfies a preset density; generating a third depth map by performing an interpolation on the first depth map based on image features of the left image and the right image; and generating a fourth depth map of the scene based on the second depth map and the third depth map.

The generating of the second depth map may include generating interpolated ToF projection points by respectively performing an interpolation, based on a corresponding image feature of the left image and the right image, on adjacent ToF projection points spaced apart in a preset distance on a corresponding scan line of each ToF projection point; determining a regular grid of a ToF projection point by sampling the interpolated ToF projection points; and generating the second depth map by respectively performing an interpolation, based on a respective image feature of the left image and the right image, on each ToF projection point on each determined regular grid.

The performing of the interpolation of the first depth map may include determining a depth value of a point to be interpolated based on a spatial distance and an image feature difference between a point to be interpolated and adjacent reference points.

The generating of the depth map without consideration of the ToF image may include generating a fifth depth map of the scene through a stereo matching of the left image and the right image.

The method may further include updating a depth value of an unreliable depth value point of the generated depth map, wherein the generated depth map comprises the fifth depth map.

The updating of the depth value may include determining a reliable depth value point and the unreliable depth value point of the generated depth map; predicting, using a second neural network, the depth value of the unreliable depth value point based on a feature of the reliable depth value point and the unreliable depth value point; and generating an updated depth map by performing an interpolation, based on corresponding image features of the left image and the right image, on an area around the unreliable depth value point.

The determining of the reliable depth value point and the unreliable depth value point may include determining a regular grid of a depth value point based on the updated depth map, and determining the reliable depth value point and the unreliable depth value point on the regular grid.

The method may further include capturing the ToF image of a scene using an ToF sensor; and capturing the left image and the right image of the scene using a color image sensor;

In another general aspect, an electronic device include one or more processors configured to execute instructions; and one or more memories storing the instructions, wherein the execution of the instructions configures the one or more processors to calculate a first reliability of each of a plurality of time of flight (ToF) pixels of a ToF image; generate, based on the first reliabilities, a depth map of a scene based on a left image a right image, and the ToF image; and generate, based on the first reliabilities, the depth map based on the left image and the right image without consideration of the ToF image.

For the calculating of the first reliabilities, the one or more processors may be configured to project each of the plurality of ToF pixels of the ToF image onto the left image and the right image; calculate a second reliability of a ToF pixel corresponding to each ToF projection point on a corresponding scan line in a first direction; and calculate, based on the second reliability, the first reliability of a ToF pixel corresponding to each ToF projection point on another corresponding scan line in a second direction that is opposite to the first direction.

For the generating of the depth map, the one or more processors may be configured to determine a first quantity of first reliability ToF pixels, of the plurality of ToF pixels, that have respective first reliabilities that satisfy a predetermined requirement; in response to the first quantity satisfying a first threshold requirement, perform the generation of the depth map based on the left image, the right image, and the ToF image; and in response to the first quantity not satisfying the first threshold requirement, perform the generation of the depth map without consideration of the ToF image.

For the performance of the generation of the depth map based on the ToF image, the one or more processors may be configured to perform a first stereo matching of the left image and the right image; predict, using a first neural network, another reliability of each of the plurality of ToF pixels based on the ToF image and a result of the first stereo matching; perform a second stereo matching of the left image and the right image based on the ToF image and the other reliabilities; and generate the depth map dependent on the performed second stereo matching.

For the performance of the generation of the depth map without consideration of the ToF image, the one or more processors may be configured to perform a third stereo matching of the left image and the right image, and generate the depth map dependent on the performed third stereo matching.

The electronic device may be further include a first sensor configured to capture the ToF image of a scene; and a second sensor configured to capture the left image and the right image of the scene.

Other features and aspects will be apparent from the following detailed description, the drawings, and the claims.

### BRIEF DESCRIPTION OF THE DRAWINGS

FIG. 1 illustrates an example method with depth information estimation according to one or more embodiments.

FIG. 2 illustrates an example configuration of a time of flight (ToF) image sensor and a color image sensor of an apparatus or system with depth estimation according to one or more embodiments.

FIG. 3 illustrates an example method with a ToF pixel reliability determination based on bidirectional propagation according to one or more embodiments.

FIG. 4 illustrates an example stereo matching of a ToF guide according to one or more embodiments.

FIG. 5 illustrates an example method with a transformer-based ToF pixel prediction according to one or more embodiments.

FIG. 6 illustrates an example projection situation of ToF points for a red, green, and blue (RGB) image according to one or more embodiments.

FIG. 7 illustrates an example grid point after an example down-sampling according to one or more embodiments.

FIGS. 8A and 8B illustrate example interpolations guided by an image feature of a left image and a right image on a regular grid according to one or more embodiments.

FIGS. 9A and 9B illustrate example interpolations guided by an image feature of a left image and a right image after irregular projection according to one or more embodiments.

FIG. 10 illustrates an example method with transformer-based unreliable depth value point updating according to one or more embodiments.

FIG. 11 illustrates an example method with depth estimation according to one or more embodiments.

FIG. 12 illustrates an example estimation apparatus with depth estimation according to one or more embodiments.

FIG. 13 illustrates an example electronic device with depth estimation according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing. It is to be understood that if a component (e.g., a first component) is referred to, with or without the term “operatively” or “communicatively,” as “coupled with,” “coupled to,” “connected with,” or “connected to” another component (e.g., a second component), it means that the component may be coupled with the other component directly (e.g., by wire), wirelessly, or via a third component.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

In AR application examples, various three-dimensional (3D) virtual objects may displayed and/or projected based on 3D information of scene objects. Obtaining 3D information of a surrounding scene may also have desirable implications for many other tasks in various embodiments, such as obstacle avoidance and grasping of an example robot. Thus, as non-limiting examples, one or more embodiments may include a method and apparatus that may obtain a more accurate and efficient estimated depth information of such a surrounding scene and perform various tasks and/or operations dependent on the estimated depth information.

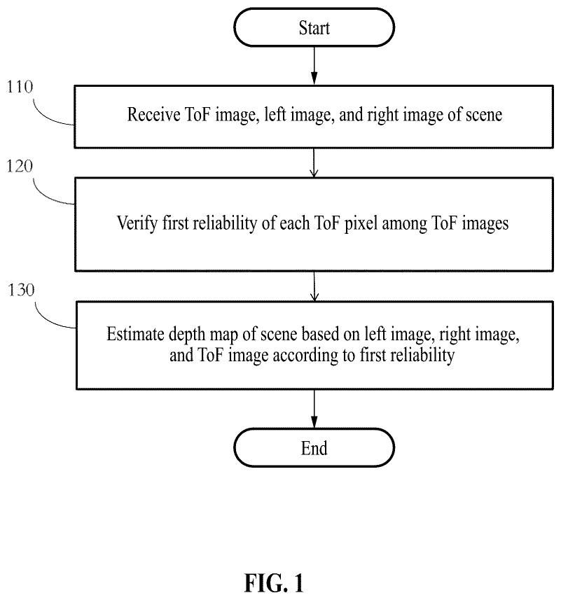

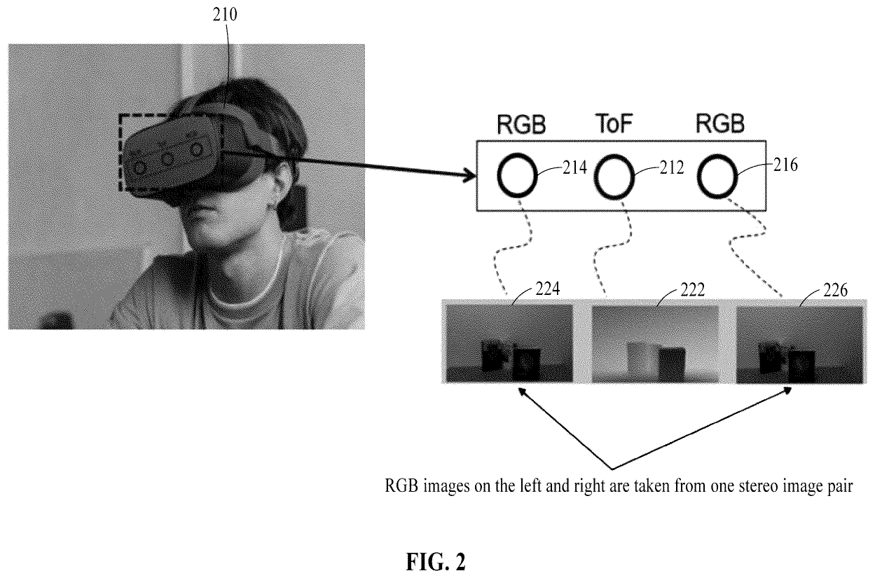

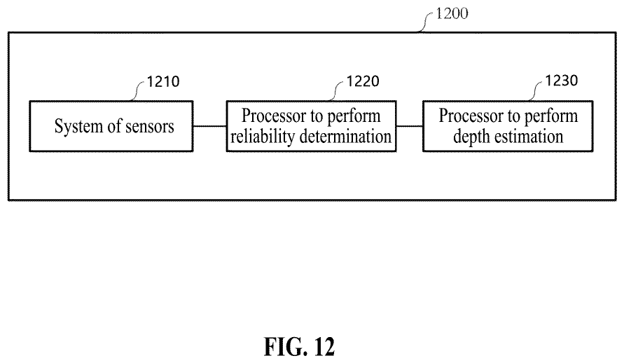

FIG. 1 illustrates an example method with depth information estimation according to one or more embodiments. The method may include operations 110 through 130 as a non-limiting example. These operations of the method are performed by one or more hardware apparatuses (e.g., an apparatus 210 in FIG. 2 or an apparatus 1200 in FIG. 12), and/or an electronic device (e.g., an electronic device 1300 in FIG. 1300), or a processor 1320 of the electronic device 1300.

Referring to FIG. 1, in operation 110, the method may include receiving a time of flight (ToF) image, a left image, and a right image of a scene or an object. As non-limiting examples, the ToF image may be obtained/captured/collected using a ToF image sensor, and the left and right images may be obtained/captured/collected using a color image sensor, or a pre-stored ToF image and the left and right images may be directly obtained from one or more memories of the apparatus or the electronic device. The ToF image sensor and the color image sensor may be part of the apparatus or the electronic device, or may be associated with the apparatus or the electronic device. The present disclosure does not limit a method of obtaining the ToF image, left image, and right image. The left and right images may be red, green, and blue (RGB) images, different types of color images, infrared images, etc.

FIG. 2 illustrates an example configuration of a ToF image sensor and a color image sensor of an apparatus or system with depth estimation according to one or more embodiments. In an example, the apparatus may be a head wearable apparatus. Accordingly, while embodiments are not limited thereto, the below explanation of FIG. 2 will refer to the apparatus as being the head wearable apparatus for convenience of explanation.

Referring to FIG. 2, a head wearable apparatus 210 that is configured to estimates depth information may include a ToF image sensor 212 and color image sensors 214 and 216 located on the same line, as a non-limiting example.

For example, as shown in FIG. 2, a ToF image 222 may be captured/obtained by the ToF sensor 212, and a left image 224 and a right image 226 corresponding to a stereo image pair may be captured/obtained by the color image sensors 214 and 216.

Referring back to FIG. 1, in operation 120, the method may include determining/calculating/verifying a first reliability of each ToF pixel among ToF images. Here, the first reliability may be a numerical value that measures the accuracy or reliability of a depth value corresponding to the ToF pixel. In addition, a second reliability, a third reliability, and a fourth reliability described herein may also be numerical values that measure the accuracy or reliability of a depth value corresponding to the ToF pixel.

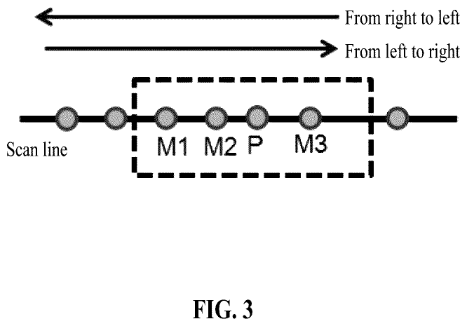

In operation 120, each ToF pixel of the ToF image (e.g., the ToF image 222) may be first projected onto the left and right images (e.g., the left and right images 224 and 226), respectively. In addition, the method may include determining/calculating the second reliability of the ToF pixel corresponding to each ToF projection point on a corresponding scan line (e.g., a scan line of FIG. 3) in a first direction, for each ToF projection point after projection. Additionally, the method may include determining/calculating/verifying the first reliability of the ToF pixel corresponding to each ToF projection point based on a reliability calculation result of the first direction, in a second direction that is opposite to the first direction.

A determining/calculating/verifying the first reliability described herein may be referred to as a “bidirectional propagation-based ToF reliability inference.” In the bidirectional propagation-based ToF reliability inference and assessment, when determining/calculating the second reliability in the first direction and the first reliability in the second direction, the second reliability and the first reliability of the ToF pixel corresponding to each ToF projection point may be calculated/determined based on the image feature difference of each ToF projection point on the left and right images and the third reliability of the ToF pixel corresponding to the ToF projection point similar to an image feature in a distance between two adjacent ToF projection points in a preset range on a corresponding scan line. As non-limiting examples, the first direction may be from left to right along the scan line of the projection point(s) and the second direction may be from right to left along the scan line of the projection point(s). Alternatively, the first direction may be from top to bottom along the scan line of the projection point(s) and the second direction may be from bottom to top along the scan line of the projection point(s).

FIG. 3 illustrates an example method with a ToF pixel reliability determination based on bidirectional propagation.

Referring to FIG. 3, when the ToF image sensor and the color image sensor may be located on the same line, the ToF pixel projected onto the left and right images may also be located on the same line. Taking the ToF pixel projected onto the left image as an example, for each ToF projection point scan line, the reliability of the ToF pixel corresponding to each ToF projection point may be calculated in two directions (e.g., the first direction from left to right, and the second direction from right to left).

In an example, the reliability calculation may be performed by projecting each ToF pixel of the ToF image onto the left and right images. Taking the left to right direction (i.e., the first direction) as an example, when ToF projection point P is given, the image feature difference of corresponding points of the left and right images may be defined as e0 and the similarity of the image features (e.g., a color feature) in a preset distance in the horizontal direction may be M1, . . . , Mn. A threshold value for determining whether the image features are similar with different image features may be set in advance. For these n points, the horizontal distance to point P may be defined as di, i=1, . . . , n, the depth difference between n points and the point P may be bi, i=1, . . . , n, and the calculated reliability may be ci, i=1, . . . , n. Accordingly, the reliability of point P may be defined as Equation 1 below.

$$\text{?} = exp ( - {a}_{0} {e}_{0} ) \frac{1}{{\sum }_{i} {c}_{i}} {\sum }_{i} {c}_{i} exp ( - {a}_{1} {d}_{i} ) exp ( - \text{?} {b}_{i} ) . \qquad Equation 1$$

$$\text{?} \text{indicates text missing or illegible when filed}$$

Here, Cₚ denotes the reliability of P, which is a ToF pixel of a ToF image and a₀, a₁, and a₂ may be preset constants. a₀, a₁, and a₂ may all be greater than “0”. For example, a₀, a₁, and a₂ may be experimental values greater than “0”.

The reliability of the ToF projection point is the reliability of the ToF pixel corresponding to the corresponding ToF projection point, and the reliability of the ToF projection point to the right of the point P from left to right directions may be temporarily unknown. For example, the reliability of the ToF projection point to the right of the point P from left to right direction may be temporarily set to a default value (e.g., “1”). That is, for a point of the reliability for which the reliability is not calculated, the reliability may be temporarily set to a default value. After calculating the second reliability of the ToF pixel corresponding to each ToF projection point from left to right, the first reliability of the ToF pixel corresponding to each ToF projection point may be calculated from right to left. For example, as shown in FIG. 3, when calculating the second reliability of the point P from left to right, the second reliability of points M1 and M2 may be already calculated, but the second reliability of point M3 located to the right of the point P may not be calculated, and the second reliability of point M3 located to the right of the point P may be temporarily set to a default value (e.g., “1”). When calculating the first reliability of the point P from right to left, the first reliability of the point M3 may be already calculated. Here, the first reliability of the point P may be calculated using the first reliability of the point M3 and the second reliability of the points M1 and M2.

The reliability inference/assessment of a ToF pixel based on bidirectional propagation may have an advantage of being faster than an existing method of using a neural network, which may help to improve the efficiency of depth estimation. At the same time, the assessed/estimated first reliability may be used to determine whether to estimate depth information of the scene based on the left image, right image, and ToF image.

Referring back to FIG. 1, in operation 130, the method may include generating/estimating a depth map of the scene based on the left image, right image, and ToF image according to the first reliability.

For example, in operation 130, the method may include determining/verifying the quantity of ToF pixels of which the first reliability satisfies a predetermined requirement, and when the quantity of ToF pixels of which the first reliability satisfies the predetermined requirement satisfies a first threshold requirement, the depth map of the scene may be generated/estimated based on the left image, right image, and ToF image.

Alternatively, in operation 130, when the quantity of ToF pixels of which the first reliability satisfies the predetermined requirement does not satisfy the first threshold requirement, the depth map of the scene may be generated/estimated based on the left and right images without using the ToF image.

For example, the method may include determining whether to generate/estimate the depth map of the scene based on the left image, right image, and ToF image based on the first reliability.

The method may include generating/estimating the depth map of the scene based on the left image, right image, and ToF image only in a situation in which the quantity of ToF pixels of which the first reliability satisfies the predetermined requirement satisfies a first threshold; otherwise, the method may include generating/estimating the depth map of the scene based on the left and right images in a situation in which the ToF image is not used. As a result, the method may avoid the high computational overhead problem due to limited information provided by the ToF image, thereby improving depth estimation efficiency and accuracy.

The generating/estimating of the depth map of the scene based on the left image, right image, and ToF image may include a stereo matching based on the left and right images in addition to the ToF image to generate/estimate the depth map of the scene.

Research may show that both the ToF camera and stereo matching have unique advantages and disadvantages. The ToF camera may process an area with accurate range and no texture very well. However, the ToF image obtained through the ToF sensor/camera may have noise and may not produce a result when the light is too strong, too dark, or at long distances. The stereo matching may not process the area with no texture very well but may not be affected by the lighting and distance. In response to this, an example method of fusing the stereo matching with the ToF image for better generating/estimating the depth information is described herein.

The generating/estimating of the depth map of the scene based on the left image, right image, and ToF image may include performing a first stereo matching of the left and right images, predicting/calculating a fourth reliability of each ToF pixel using a first neural network based on the ToF image and a result of the first stereo matching, and generating/obtaining a first depth map of the scene by performing a second stereo matching of the left and right images based on the ToF image and the predicted fourth reliability. For example, the first neural network may be, but is not limited to, a transformer.

As described above, the method may include generating/estimating the depth map of the scene based on the left image, right image, and ToF image when the quantity of ToF pixels of which the first reliability satisfies a predetermined requirement satisfies the first threshold. For example, the method may include generating/estimating the depth map of the scene based on the stereo matching of the left and right images in addition to the ToF image when the quantity of ToF pixels of which the first reliability satisfies the predetermined requirement satisfies the first threshold. Specifically, when the quantity of ToF pixels of which the first reliability satisfies the predetermined requirement satisfies the first threshold requirement, the present disclosure may also adopt different fusion methods depending on whether a second threshold requirement is more satisfied. For example, the selection of the first threshold and the second threshold among the first threshold requirement and the second threshold requirement may be related to the quantity of ToF pixels in the ToF image and/or the precision/accuracy of the ToF sensor/camera used to capture/obtain the ToF image. For example, the more ToF pixels in the ToF image and/or the higher the precision/accuracy of the ToF sensor/camera, the higher the first threshold and the second threshold may be.

For example, in the different fusion methods, before predicting the fourth reliability of each ToF pixel using the first neural network, the first stereo matching of the left and right images may be performed by adopting another method. For example, when the quantity of ToF pixels of which the first reliability satisfies the predetermined requirement satisfies the first threshold requirement and the second threshold requirement, the first stereo matching of the left and right images may be performed based on the first reliability and ToF image. Alternatively, when the quantity of ToF pixels of which the first reliability satisfies the predetermined requirement satisfies the first threshold requirement and does not satisfy the second threshold requirement, the first stereo matching of the left and right images may be performed in a situation in which the ToF image is not used. In a situation in which the ToF image is not used, the first stereo matching of the left and right images may be performed using any other stereo matching method that does not rely on the ToF image.

Here, the performing of the first stereo matching of the left and right images based on the first reliability and ToF image is described. For example, a method of performing the first stereo matching of the left and right images based on the first reliability and ToF image may include calculating a matching cost of a candidate disparity corresponding to each ToF pixel during the first stereo matching and determining a disparity value corresponding to each ToF pixel based on the calculated matching cost.

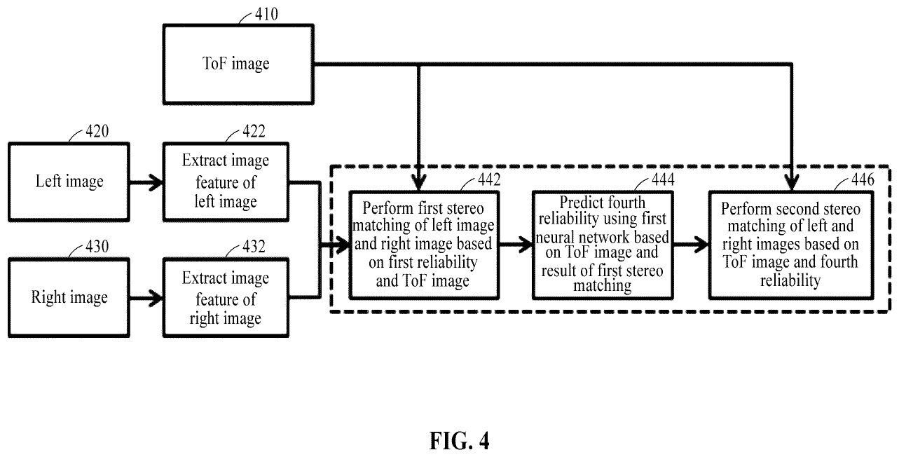

For example, when performing the first stereo matching of the left and right images based on the first reliability and ToF image, a semi global matching (SGM) may be used as a reference method of the stereo matching. SGM may have fast performance without being affected by domain conversion. However, the ToF pixel may often have noise. Accordingly, during the stereo matching using SGM, a method of calculating the matching cost of the candidate disparity corresponding to each ToF pixel during the SGM stereo matching may be proposed herein based on a value of each ToF pixel of the ToF image and the reliability of each ToF pixel. For example, the weight used to calculate the matching cost may be defined based on the first reliability. For convenience of description, the stereo matching method considering the ToF reliability may be referred to as a “stereo matching of a ToF guide” herein (see FIG. 4).

FIG. 4 illustrates an example stereo matching of a ToF guide according to one or more embodiments.

Referring to FIG. 4, in operations 422 and 432, image features of a left image 420 and a right image 430 may be extracted, respectively. For example, the image features of the left image 420 and the right image 430 may be extracted using a convolutional neural network (CNN). The method may include executing an SGM stereo matching algorithm separately on each scan line. However, when executing the SGM stereo matching algorithm, the matching cost of the candidate disparity corresponding to each ToF pixel may be determined based on the weighted sum of a first matching cost determined based on an image block matching of the left image 420 and the right image 430 and a second matching cost determined based on each ToF pixel. Here, the weight of the second matching cost used to perform the weighted sum may be defined based on the first reliability. The higher the first reliability, the greater the weight of the second matching cost. Here, the closer the candidate disparity is to the disparity corresponding to the ToF pixel, the closer the second matching cost is to “0”. This method may make the disparity value obtained during the stereo matching more accurate.

In operation 442, the method may perform the first stereo matching of the left image 420 and the right image 430 based on the first reliability and a ToF image 410. In operation 444, the method may predict the fourth reliability of each ToF pixel using the first neural network (e.g., the transformer) based on the ToF image 410 and the result of the first stereo matching. The fourth reliability of each ToF pixel may verify the ToF image 410 for each scan after projecting the ToF image 410 onto the left image 420 and the right image 430.

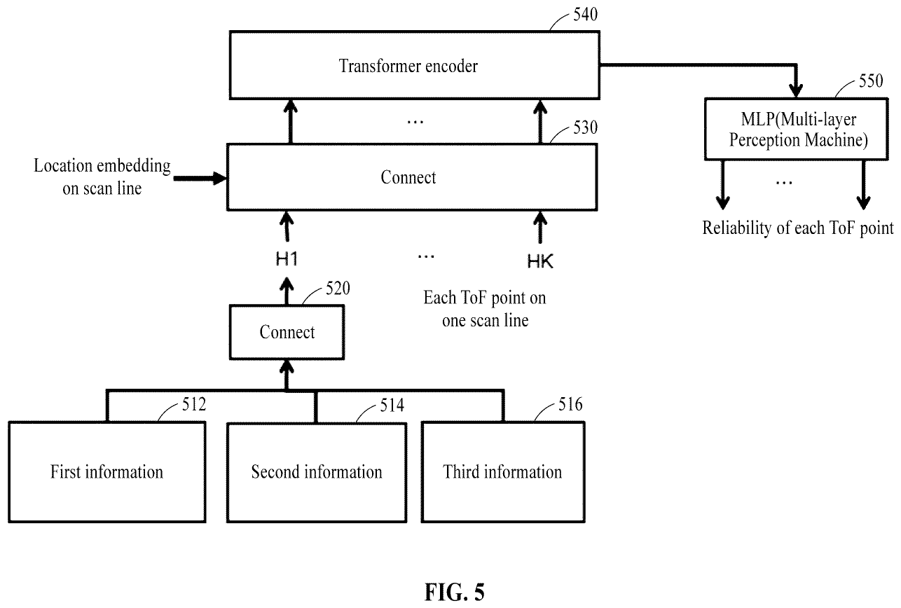

FIG. 5 illustrates an example method with a transformer-based ToF pixel prediction according to one or more embodiments.

Referring to FIG. 5, the method may use at least one type of information (first information 512, second information 514, or third information 516) as an input to the first neural network to predict the fourth reliability of each ToF pixel.

The first information 512 may be the difference between a disparity value corresponding to each ToF pixel determined in the ToF image and a disparity value of each ToF pixel determined through the first stereo matching. The second information 514 may be the image feature difference of each ToF pixel at the projection point of the left image and the right image. The third information 516 may be the difference of depth values between the projection point of each ToF pixel on the left image and the right image and at least one ToF projection point similar to an image feature in an area at the corresponding projection point.

Here, the disparity value corresponding to each ToF pixel determined based on the ToF image may be obtained by converting a depth value of each ToF pixel among the ToF images. The image feature difference (the second information 514) of at the projection point of each ToF pixel of the left image and the right image may be obtained by comparing the image features at the projection point after obtaining the corresponding projection point by projecting the ToF image onto the left and right images. The difference (the third information 516) of the depth values between the projection point of each ToF pixel on the left image and the right image and at least one ToF projection point similar to the image feature in the adjacent area of the corresponding projection point may be determined, after obtaining the corresponding projection point by projecting the ToF image onto the left and right images, by searching for the ToF projection point similar to the image feature in the preset distance of the projection point on the projection point scan line and comparing the depth values between the corresponding projection point and the ToF projection point. In operations 520 and 530, the first information 512, the second information 514, and the third information 516 may be connected to each other and sent to a transformer encoder 540 to be encoded. The encoded result may be input to a multi-layer perception (MLP) machine 550 for decoding, and the reliability of each ToF point may be obtained as a decoded result. The transformer encoder 540 of FIG. 5 may optionally use a swin-transformer (Liu Z, Lin Y, Cao Y, et al. Swin Transformer: Hierarchical vision transformer using shifted windows. ICCV, 2021), which has processing speed faster than a general transformer.

Referring back to FIG. 4, the method may predict the fourth reliability of the ToF pixel using the first neural network in operation 444, and then, the method may estimate the first depth map of the scene by performing the second stereo matching of the left and right images based on the ToF image and the predicted fourth reliability in operation 446.

Specifically, the method may include calculating the matching cost of the candidate disparity corresponding to each ToF pixel during the second stereo matching based on the value of each ToF pixel of the ToF image and the predicted fourth reliability of each ToF pixel. The method may determine the disparity value corresponding to each ToF pixel based on the matching cost and estimate the first depth map based on the determined disparity value. The method of “performing the second stereo matching of the left and right images based on the value of each ToF pixel of the ToF image and the predicted fourth reliability of each ToF pixel” may be the same as the method of “performing the first stereo matching of the left and right images based on the value of each ToF pixel of the ToF image and the first reliability of each ToF pixel”, and a difference may be that what is used here is the fourth reliability of each ToF pixel predicted based on the transformer and what is previously used is the first reliability of each ToF pixel. Accordingly, further description is omitted here and related description is provided above.

As described above, in the ToF guide stereo matching, the matching cost during the stereo matching may be calculated based on the value of the ToF pixel and the reliability of the ToF pixel, thereby improving the accuracy of depth estimation and generating/obtaining a more accurate depth map.

In an example, to obtain a denser and more accurate depth map, the method may further include projecting the ToF image onto the left and right images and estimating a second depth map by performing an interpolation on a ToF projection point area that satisfies preset density based on the image features of the left and right images, estimating a third depth map by performing an interpolation on the first depth map based on the image features of the left and right images, and estimating a fourth depth map of the scene based on the second depth map and the third depth map. The “performing an interpolation guided by the image features of the left and right images” may refer to performing an interpolation based on the image features of the left and right images, that is, performing an interpolation by considering the image features of the left image and an existing image.

The interpolation guided by the image features of the left and right images (also referred to as an “interpolation of an RGB guide” herein) may refer to using the image features of the left and right images for the interpolation. In the interpolation guided by the image features of the left and right images, the depth value of a point to be interpolated may be determined based on the spatial distance and the image feature difference between the point to be interpolated and adjacent reference points. For example, the image feature difference may be the difference of color features (also referred to as a “color distance”) but is not limited thereto. The interpolation of the RGB guide may consider the image features of the left and right images, thereby improving the accuracy of interpolation.

The method may determine the point to be interpolated and adjacent reference points based on an object to be interpolated. Depending on different objects of the point to be interpolated, the point to be interpolated and the adjacent reference points may represent different points. For example, when the object to be interpolated is in the ToF projection point area, the point to be interpolated and the adjacent reference points may become the ToF projection point. For example, when the object to be interpolated is the depth map, the point to be interpolated and the adjacent reference points may become a depth value point. For example, the point to be interpolated may be a point in an area where the ToF projection points are concentrated excluding the existing ToF projection point. The adjacent reference points may be the ToF projection point on the four corners of a rectangular grid with the point to be interpolated.

Due to the high computational amount involved in calculating the spatial distance (e.g., a Euclidean distance), to increase the computational amount, the ToF image may be first projected onto the left and right images and the interpolation of the RGB guide may be performed on the ToF projection point area that satisfies the preset density on the regular grid.

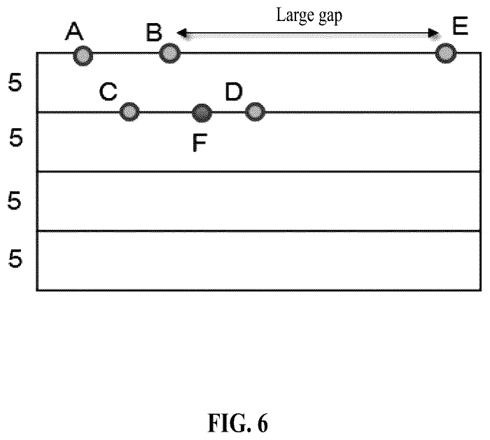

FIG. 6 illustrates an example projection situation of ToF points for an RGB image according to one or more embodiments.

Referring to FIG. 6, when projecting the ToF pixel of the ToF image onto the left and right images, an initial result may be an irregular grid point. That is, the ToF point on the same line may still be on the same projection scan line after projection but the distance between adjacent ToF points may no longer be regular. Accordingly, the interpolation guided by the image features of the left and right images may be first performed on the adjacent ToF projection points spaced apart in a preset distance on the scan line of each ToF projection point. For example, point F may be interpolated between points C and D. An area with a large spacing (e.g., a large gap between points B and E) after projection may be typically very discontinuous and may have a significant error that is not visible in the ToF camera. Accordingly, the interpolation may only be performed in the ToF projection point area that satisfies the preset density. When the distance between two adjacent ToF projection points is greater than the preset spacing on the scan line, the interpolation may not be performed. For example, the preset spacing may be related to the spacing between two ToF pixels in the ToF image. For example, the preset spacing may be a predetermined multiple (e.g., three times) of the spacing between two ToF pixels in the ToF image. In an example, if the large gap between the two points B and E is greater than the preset spacing on the scan line, the interpolation may not be performed between the points B and E.

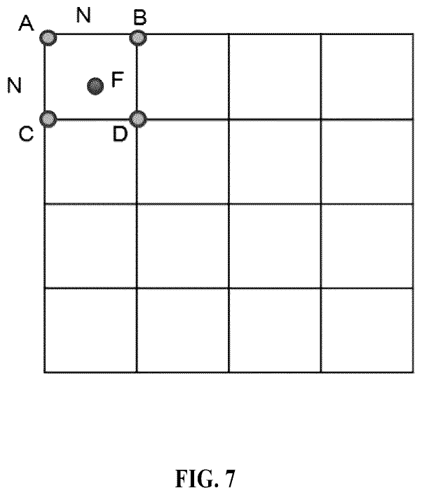

Second, the method may sample the interpolated ToF projection point and form a ToF projection point regular grid. For example, a schematic diagram of a grid point after down-sampling may be shown in FIG. 7. Finally, the interpolation guided by the image features of the left and right images may be performed on each formed grid.

FIG. 7 illustrates an example grid point after an example down-sampling according to one or more embodiments.

Referring to FIG. 7, in the method, when four points A, B, C, and D are given on the grid point, the depth value of the point F to be interpolated may be inferred in the rectangle surrounded by the four points A, B, C, and D. For example, the width of a small grid is given, the length of A to B may be N and the calculation method of the depth value of the point F may be, for example, as shown in Equation 2 below.

$${d}_{F} = {\sum }_{i ∈ \{ A , B , C , D \}} {d}_{i} {w}_{i} \text{?} \qquad Equation 2$$

$${w}_{A} ∝ ( N - \text{?} ) ( N - \text{?} ) \times exp ( - a {‖ {H}_{A} - {H}_{F} ‖}_{1} )$$

$$\text{?} \text{indicates text missing or illegible when filed}$$

Here X_{A,F} and Y_{A,F} denote spatial distances in the x- and y-axis directions between the point A and the point F, respectively, H_{A} and H_{F} denote color values at the point A and the point F, and a denotes a constant greater than “0”.

To increase the processing speed, according to the equation of calculating W_{A}, a coefficient Wᵢ related to the spatial distance and color distance may be calculated in advance and stored in a table and the value may be determined through a table lookup.

Although an example of a method of calculating the depth value of the point F is described above, the method of calculating the depth value of the point F is not limited to the above example and may be any suitable method of determining the depth value of the point F based on the spatial distance and the image feature difference between the adjacent reference points A, B, C, and D and the point F.

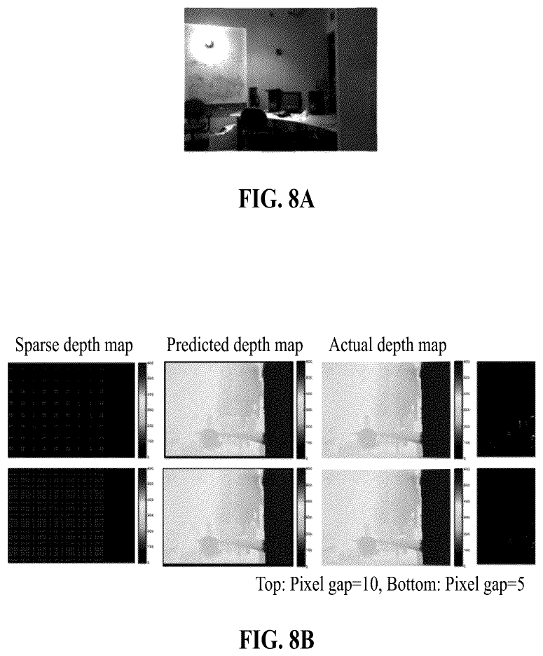

FIGS. 8A and 8B illustrate examples of performing an interpolation guided by an image feature of a left image and a right image on a regular grid according to one or more embodiments.

Referring to FIGS. 8A and 8B, FIG. 8A is an RGB image and FIG. 8B shows an interpolation result at different pixel spacing (grid widths). In order from the left, a sparse depth map (i.e., the depth map before the interpolation), a predicted depth map (i.e., the depth map after the interpolation), an actual depth map, and the difference between the actual depth map and the predicted depth map may be shown. In FIGS. 8A and 8B, it may be seen that the narrower the grid width, the less the difference between the predicted depth map and the actual depth map.

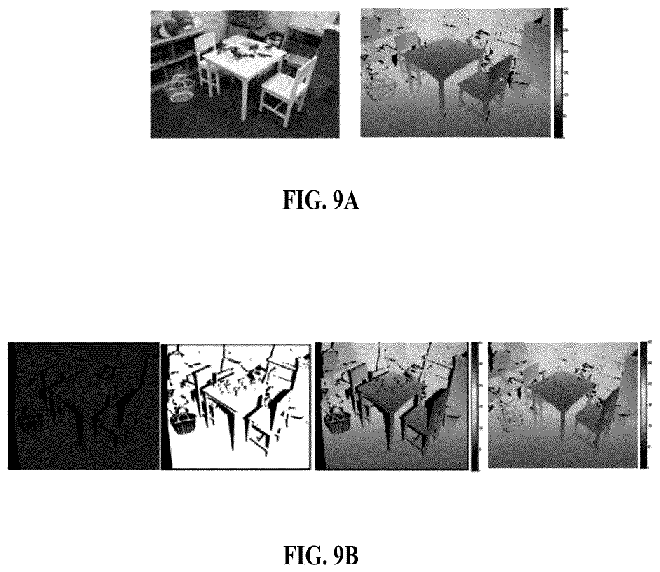

FIGS. 9A and 9B illustrate examples of an interpolation guided by an image feature of a left image and a right image after irregular projection according to one or more embodiments.

Referring to FIGS. 9A and 9B, FIG. 9A shows a left RGB image and the ToF image. Here, projecting the ToF image onto the left RGB image may be taken as an example. FIG. 9B sequentially shows an interpolation effect on a sparse scan line, an effect of performing the interpolation of the RGB guide on the regular grid to fill a dense ToF projection point area, and a predicted depth map and an actual depth map. Here, the predicted depth map may be the second depth map described above.

As non-limiting examples, the “projecting the ToF image onto the left and right images and estimating the second depth map by performing the interpolation on the ToF projection point area that satisfies preset density based on the image features of the left and the right images” may be executed before or after “performing the first stereo matching of the left and right images in a situation in which the ToF image is not used” or executed before or after “performing the first stereo matching of the left and right images based on the first reliability and ToF image.” In addition, when estimating the second depth map, the method may estimate the third depth map by performing the interpolation guided by the image features of the left and right images on the first depth map. Finally, the fourth depth map of the scene may be further estimated based on the second depth map and the third depth map. A more accurate depth map may be obtained through additional fusion of the depth map.

For example, the method may obtain the fourth depth map by weighted-averaging of the depth values of an area around a reliable ToF pixel among the second depth map and the third depth map. Here, the weight during weighted-averaging may vary depending on the fourth reliability of the ToF pixel. When there is a corresponding ToF pixel for which the fourth reliability is calculated prior to the weighted depth value, the weight of the corresponding depth value may be determined based on the fourth reliability of the ToF pixel. When there is no corresponding ToF pixel for which the fourth reliability is calculated prior to the weighted depth value, the method may determine the weight of the depth value based on the fourth reliability of the nearest ToF pixel.

As described above, I method that fuses the ToF image and the stereo matching may estimate the depth map by effectively integrating the advantages of both the ToF image and stereo matching.

However, in some cases, a hidden area of the scene may not be seen by both the ToF camera and the RGB camera, so the depth information of the hidden area may not be accurately estimated. The problem of inaccurate depth information estimation due to such occlusion may occur in the method of estimating the depth information based on the left and right images without using the ToF image in addition to the method of estimating the depth map based on the left image, right image, and ToF image. For example, the method of estimating the depth information of the scene based on the left and right images in a situation in which the ToF image is not used may include obtaining a fifth depth map of the scene through the stereo matching of the left and right images in a situation in which the ToF image is not used. However, the depth value of the hidden area in the estimated depth map may not be accurate enough. The present disclosure may additionally propose updating the depth value corresponding to such hidden area to obtain the more accurate depth map. Accordingly, the method may further include updating the depth value of an unreliable depth point among the estimated depth maps, where the estimated depth maps may include the first depth map, the fourth depth map, or the fifth depth map.

Specifically, the method may first determine a reliable depth value point and an unreliable depth value point of the estimated depth map in the update operation. Second, the method may predict the depth value of the unreliable depth value point using a second neural network based on the features of the reliable depth value point and the unreliable depth value point. Finally, the method may estimate the updated depth map by performing the interpolation guided by the image features of the left and right images on the area around the unreliable depth value point. The method of updating the depth map may effectively use global semantic information for depth inference, thereby generating/estimating a more accurate depth map. The second neural network may be the transformer but is not limited thereto.

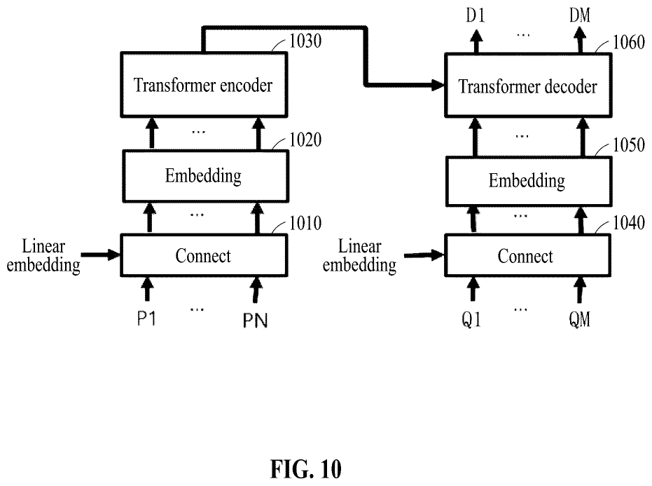

FIG. 10 illustrates an example method with transformer-based unreliable depth value point updating according to one or more embodiments.

Referring to FIG. 10, to improve the update speed, a regular grid of depth value points may be formed based on the estimated depth map and the reliable depth value point and the unreliable depth value point may be determined on the regular grid. When the estimated depth map is the first depth map described above, the method may first perform the interpolation of the RGB guide on the first depth map. Then, the method may form the regular grid by sampling the depth value point for the first depth map. In addition, the method may determine the reliable depth value point and the unreliable depth value point on the grid.

When the estimated depth map is the fourth depth map described above, the method may form the regular grid by directly sampling the fourth depth map and determine the reliable depth value point and the unreliable depth value point on the grid. The method of forming the regular grid is described above and further description thereof is not repeated herein.

The method may form the regular grid and then determine the reliable depth value points (e.g., P1 through PN in FIG. 10) and the unreliable depth value points (e.g., Q1 through QM in FIG. 10) on the regular grid. Generally, in the case of the unreliable depth value point, the adjacent distance between the corresponding ToF projection points may be relatively long or the feature difference between the corresponding left and right images may be large. Accordingly, based on this, the unreliable depth value point may be identified and a depth value point other than the unreliable depth value point may be determined as the reliable depth value point.

The method may determine the reliable depth value point and the unreliable depth value point on the regular grid, and the feature (e.g., the depth feature or the image feature corresponding to the depth value point, etc.) of the reliable depth value point may be connected to location information on the regular grid in operation 1010, may be further linearly embedded in operation 1020, and finally may be input to a transformer encoder 1030 for encoding.

In addition, the method may connect the feature of the unreliable depth value point and the location information on the regular grid in operation 1040, input a result obtained by further linear embedding in operation 1050 to a transformer decoder 1060 with a result of encoding with the transformer encoder 1030, and predict or decode the depth value (e.g., D1 through DM in FIG. 10) of the unreliable depth value point.

Finally, the method may obtain the updated depth map by performing the interpolation guided by the image features of the left and right images on the area around the unreliable depth value point. The interpolation guided by the image features of the left and right images is described above, and further description thereof is not repeated herein. By updating the depth value on the regular grid points, the processing speed is effectively improved.

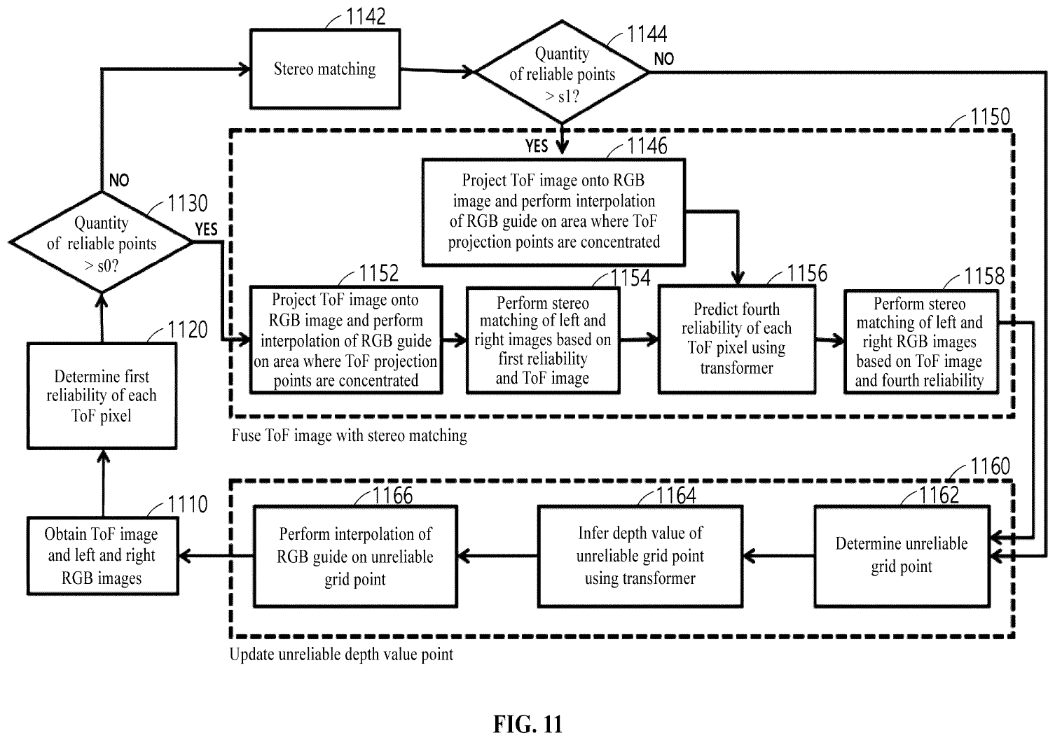

The method is described above with reference to FIGS. 1 through 10. Hereinafter, for convenience of understanding, an example of the method is described below with reference to FIG. 11.

FIG. 11 illustrates an example method with depth information estimation according to one or more embodiments.

Referring to FIG. 11, the method may obtain one ToF image and two RGB images (left and right RGB images) at a current time t in operation 1110 and then may rapidly determine the first reliability of each ToF pixel using above-described bidirectional propagation-based ToF reliability inference method in operation 1120.

In operation 1130, the method may verify whether the quantity (the quantity of reliable points) of ToF pixels of the first reliability that satisfies a predetermined requirement is greater than s0.

As a result of the verification in operation 1130, when the quantity (the quantity of reliable points) of ToF pixels of the first reliability that satisfies the predetermined requirement is greater than s0, the depth estimation method may estimate the depth map of the scene by fusing the ToF image with the stereo matching in operation 1150. For example, in operation 1152, in a fusion method, the ToF image may first be projected onto the left RGB image and the right RGB image, respectively, and may perform the interpolation of the RGB guide on the area where ToF projection points are concentrated (the area where ToF the points are concentrated). In operation 1154, the method may perform the stereo matching of the left and right RGB images based on the first reliability and ToF image. In operation 1156, the fourth reliability of each ToF pixel may be predicted using the transformer based on the ToF image and a result of the stereo matching. In operation 1158, the method may perform the stereo matching of the left and right RGB images based on the ToF image and the predicted fourth reliability.

As a result of the verification in operation 1130, when the quantity of the reliable points is too small (less than or equal to s0), the method may directly perform the stereo matching in operation 1142.

In operation 1144, the method may verify a case in which the quantity of the reliable points is not greater than s0 but greater than s1.

As a result of the verification in operation 1144, when the quantity of the reliable points is not greater than s0 but greater than s1, the method may estimate the depth map of the scene by fusing the ToF image with the stereo matching. In operation 1146, a fusion method may project the ToF image onto the RGB image after performing the stereo matching of the left and right images in a situation in which the ToF image is not used and may perform the interpolation of the RGB guide on the area where the ToF projection points are concentrated. In operation 1156, the method may predict the fourth reliability of each ToF pixel using the transformer based on the ToF image and the result of the stereo matching. In operation 1158, the method may perform the stereo matching of the left and right images based on the ToF image and the predicted fourth reliability. Here, the interpolation and stereo matching may be relatively independent. In both processing methods, the interpolation may be performed first before the stereo matching or the stereo matching may be performed first before the interpolation.

In operation 1160, the depth map obtained in the above process may additionally update the unreliable depth value point, thereby obtaining the updated depth map. Specifically, this update may be performed on the grid points. For example, as shown in FIG. 10, in operation 1162, the method may first determine the unreliable depth value point (the unreliable grid point) on the regular grid.

In operation 1164, the method may infer the depth value of the unreliable grid point using the transformer. In operation 1166, the method may estimate the updated depth map by performing the interpolation of the RGB guide on the area around the unreliable grid point.

The method may be applied to the AR field. For example, the depth estimation method may be applied to the rendering of a virtual object in an AR application, interaction of a virtual object with real space, or image projection correction in video see through (VST).

For example, the method may be applied to a head wearable smart apparatus such as smart glasses. The smart glasses may include a ToF image sensor and a pair of color image sensors. After obtaining the ToF image of the scene through the ToF image sensor and the left and right images of the scene through the color image sensors, the depth map of the scene may be estimated using the method. Using the estimated depth map, the smart glasses may determine the depth value of each object on the scene and display the virtual object on or around an object expected to interact with a wearer and the virtual object according to the determined depth value, and the wearer may further interact with the displayed virtual object such as gameplay. Through the combination of the virtual object and the object in real space, the wearer may experience an immersive feeling.

The method with depth estimation is described above with reference to FIGS. 1 through 11. According to the above-described method with depth estimation, the depth information of the scene may be estimated more accurately and efficiently.

FIG. 12 illustrates an example estimation apparatus with depth estimation according to one or more embodiments.

Referring to FIG. 12, a depth estimation apparatus 1200 may include a system of sensors 1210, a processor 1220, and a processor 1230. Specifically, the system of sensors 1210 may be configured to obtain the ToF image, left image, and right image of the scene. The processor 1220 may be configured to determine the first reliability of each ToF pixel among the ToF images. The processor 1230 may be configured to estimate the depth map of the scene based on the left image, right image, and ToF image according to the first reliability. In an example, the apparatus 1200 may include another processor to update the depth value of the unreliable depth value point in the estimated depth map.

The method with depth estimation shown in FIG. 1 may be performed by the apparatus 1200 shown in FIG. 12. The system of sensors 1210, the processor 1220, and the processor 1230 may perform operations 110, 120, and 130, respectively. A detailed description related to operations by each component in FIG. 12 may refer to the corresponding description in FIGS. 1 through 11, and thus, further description thereof is not repeated herein. The processors 1220 and 1230 may be different processors or a same processor, as well as other processor configured to perform the respective operations as discussed above.

In addition, the apparatus 1200 is described to be divided into the system of sensors 1210, the processor 1220, and the processor 1230 to perform the corresponding processing separately. In an example, the processing performed by the system of sensors 1210, the processor 1220, and the processor 1230 may be performed in the apparatus 1200 without division or clear boundaries between components. In addition, the apparatus 1200 may further include one or more memories storing the instructions. In an example, the execution of instructions may configure one or more processors (i.e., any one or any combination of the different or same processors) to operate the system of sensors 1210, the processor 1220, and the processor 1230, respectively.

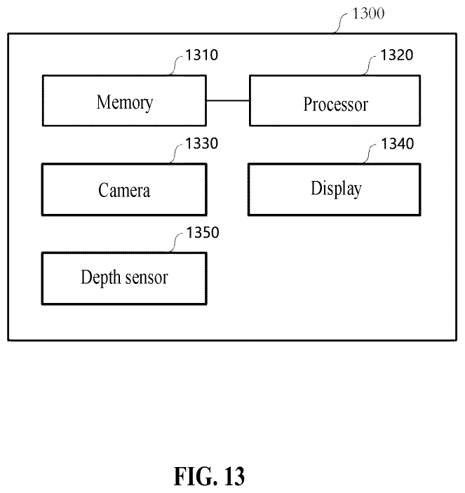

FIG. 13 illustrates an example electronic device with depth estimation according to one or more embodiments.

Referring to FIG. 13, an electronic device 1300 may include at least one memory 1310, at least one processor 1320, a camara 1330, a display 1340 and a depth sensor as a non-limiting example. The at least one memory 1310 may store computer-executable instructions and when the computer-executable instructions are executed by at least one processor 1320, at least one processor 1320 may control the camera 1330, the display 1340 and the depth sensor 1350, and execute any one or any combination of the depth estimation operations described herein.

At least one component among the plurality of components may be implemented through an artificial intelligence (AI) model. AI-related functions may be performed by a non-volatile memory, a volatile memory, and the processor 1320.

The processor 1320 may include at least one processor 1320. Here, at least one processor 1320 may be, for example, general-purpose processors (e.g., a central processing unit (CPU) and an application processor (AP), etc.), or graphics-dedicated processors (e.g., a graphics processing unit (GPU) and a vision processing unit (VPU)), and/or AI-dedicated processors (e.g., a neural processing unit (NPU)).

At least one processor 1320 may control processing of input data according to a predefined operation rule or an AI model stored in a non-volatile memory and a volatile memory. The predefined operation rule or AI model may be provided through training or learning. Here, providing the predefined operation rule or AI model through learning may indicate obtaining a predefined operation rule or AI model with desired characteristics by applying a learning algorithm to a plurality of pieces of training data. The training may be performed by a device having an AI function or by a separate server, device, and/or system.

The learning algorithm is a method of inducing, allowing, or controlling a target device to determine or predict a target device by training a predetermined target device (e.g., a robot) using multiple learning data. The learning algorithm may include, but is not limited to, for example, supervised learning, unsupervised learning, semi-supervised learning, or reinforcement learning.

In the image processing method executed by the electronic device 1300, an output image after processing a target area may be obtained using an input image as input data for an AI model.

The AI model may be obtained through training. Here, t“e “obtaining through train”ng” may indicate training an AI model configured to execute a predefined operation rule or desired characteristics (or goals) by training a basic AI model with multiple training data through a training algorithm.

For example, the AI model may include a plurality of neural network layers. Each neural network layer may have a plurality of weighted values, and the calculation of one layer may be performed by a calculation result of a previous layer and a plurality of weights of a current layer. A neural network may include, for example, a CNN, a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network but is not limited thereto. For example, the electronic device 1300 may be a personal computer (PC), tablet device, personal digital assistant (PDA), smartphone, or another device capable of executing the above-described instruction set. Here, the electronic device 1300 may not need to be a single electronic device and may be a device or assembly of a circuit capable of executing the instructions (or the instruction set) individually or jointly. The electronic device 1300 may also be a part of an integrated control system or a system administrator or may be configured as a portable electronic device that interfaces locally or remotely (e.g., via wireless transmission).

In the electronic device 1300, the processor 1320 may include a CPU, a GPU, a programmable logic device, a dedicated processor system, a microcontroller, or a microprocessor. In addition, the processor 1320 may further include, for example, an analog processor, a digital processor, a microprocessor, a multicore processor, a processor array, or a network processor.

The processor 1320 may execute instructions or code stored in the memory 1310, among which the memory 1310 may further store data. Instructions and data may also be transmitted and received over a network via a network interface that may use any known transport protocol.

The memory 1310 may be integrated with the processor 1320 by arranging random-access memory (RAM) or flash memory, for example, in an integrated circuit microprocessor. In addition, the memory 1310 may also include a separate device such as an external disk drive, a storage array, or other storage devices that may be used by any database system. The memory 1310 and the processor 1320 may be operatively combined or communicate with each other through input/output (I/O) ports and network connections, allowing the processor 1320 to read files stored in the memory 1310.

In addition, the electronic device 1300 may further include a video display (e.g., a liquid crystal display (LCD)) and a user interaction interface (e.g., a keyboard, a mouse, or a touch input device). All components of the electronic device 1300 may be connected to each other through a bus and/or a network.

The processors, memories, electronic devices, apparatuses, and components described herein with respect to FIGS. 1-13 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular te“m “proces”or” “r “compu”er” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media.

Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, Bd-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method of estimating depth, the method comprising:
calculating a first reliability of each of a plurality of time of flight (ToF) pixels of a ToF image; and
generating, based on the first reliabilities, a depth map of a scene based on a left image and a right image and selectively based on the ToF image.

2. The method of claim 1, wherein the calculating of the first reliabilities comprises:
projecting each of the plurality of ToF pixels onto the left image and the right image;
calculating a second reliability of a respective second ToF pixel, of the plurality of ToF pixels, corresponding to each second ToF projection point on a second corresponding scan line in a first direction; and
calculating, based on the calculating of the second reliability, the first reliability of a respective first ToF pixel, of the plurality of ToF pixels, corresponding to each first ToF projection point on a first corresponding scan line in a second direction that is opposite to the first direction.

3. The method of claim 2, wherein the calculating of the second reliabilities and the calculating of the first reliabilities are based on an image feature difference of each second ToF projection point of the left image and the right image and a third reliability of a ToF pixel corresponding to a ToF projection point determined similar to an image feature in which a distance between each second ToF projection point is in a preset range on the second corresponding scan line.

4. The method of claim 1, wherein the generating of the depth map comprises:
determine a first quantity of first reliability ToF pixels, of the plurality of ToF pixels, that have respective first reliabilities that satisfy a predetermined requirement;
selecting, in response to the first quantity satisfying a first threshold requirement, to generate the depth map based on the ToF image; and
selecting, in response to the first quantity not satisfying the first threshold requirement, to generate the depth map without consideration of the ToF image.

5. The method of claim 4, wherein the generating of the depth map based on the ToF image comprises:
performing a first stereo matching of the left image and the right image, including a determination of first matched ToF pixels;
predicting, using a first neural network, a fourth reliability of each of the plurality of ToF pixels based on the ToF image and a result of the first stereo matching; and
generating a first depth map of the scene by performing a second stereo matching of the left image and the right image based on the ToF image and the fourth reliabilities.

6. The method of claim 5,
wherein the selecting, to generate the depth map based on the ToF image, is based on the first reliabilities and the ToF image in response to a second quantity of second ToF pixels, of the plurality of ToF pixels, that have respective first reliabilities that satisfy the first threshold requirement and a second threshold requirement; or
wherein the selecting, to generate the depth map without the consideration of the ToF image, is based on a third quantity of third ToF pixels, of the plurality of ToF pixels that have respective first reliabilities that satisfy the first threshold requirement and do not satisfy the second threshold requirement.

7. The method of claim 5, wherein the predicting of the fourth reliabilities comprises predicting the fourth reliabilities using at least one piece of information among first information, second information, and third information as an input to the first neural network,
wherein the first information is a difference between a disparity value corresponding to each of the plurality of ToF pixels and a disparity value of each of first matched ToF pixels,
wherein the second information is an image feature difference of each of the plurality of ToF pixels of a corresponding projection point of the left image and the right image, and
wherein the third information is a difference of depth values between the corresponding projection points and at least one ToF projection point having a determined similar feature in a corresponding projection point area.

8. The method of claim 5, wherein the generating of the first depth map comprises:
calculating a respective matching cost of a candidate disparity corresponding to each of the plurality of ToF pixels during the second stereo matching based on a respective value of each of the plurality of ToF pixels and the predicted fourth reliabilities of each of the plurality of ToF pixels;
determining a respective disparity value corresponding to each of the plurality of ToF pixels based on the respective matching cost; and
estimating the first depth map using the determined respective disparity value.

9. The method of claim 5, wherein the generating of the depth map comprises:
projecting the ToF image onto the left image and the right image and generating a second depth map by performing an interpolation, based on corresponding image features of the left image and the right image, on a ToF projection point area that satisfies a preset density;
generating a third depth map by performing an interpolation on the first depth map based on image features of the left image and the right image; and
generating a fourth depth map of the scene based on the second depth map and the third depth map.

10. The method of claim 9, wherein the generating of the second depth map comprises:
generating interpolated ToF projection points by respectively performing an interpolation, based on a corresponding image feature of the left image and the right image, on adjacent ToF projection points spaced apart in a preset distance on a corresponding scan line of each ToF projection point;
determining a regular grid of a ToF projection point by sampling the interpolated ToF projection points; and
generating the second depth map by respectively performing an interpolation, based on a respective image feature of the left image and the right image, on each ToF projection point on each determined regular grid.

11. The method of claim 9, wherein the performing of the interpolation of the first depth map comprises determining a depth value of a point to be interpolated based on a spatial distance and an image feature difference between a point to be interpolated and adjacent reference points.

12. The method of claim 4, wherein the generating of the depth map without consideration of the ToF image comprises generating a fifth depth map of the scene through a stereo matching of the left image and the right image.

13. The method of claim 12, further comprising:
updating a depth value of an unreliable depth value point of the generated depth map, wherein the generated depth map comprises the fifth depth map.

14. The method of claim 13, wherein the updating of the depth value comprises:
determining a reliable depth value point and the unreliable depth value point of the generated depth map;
predicting, using a second neural network, the depth value of the unreliable depth value point based on a feature of the reliable depth value point and the unreliable depth value point; and
generating an updated depth map by performing an interpolation, based on corresponding image features of the left image and the right image, on an area around the unreliable depth value point.

15. The method of claim 14, wherein the determining of the reliable depth value point and the unreliable depth value point comprises determining a regular grid of a depth value point based on the updated depth map, and determining the reliable depth value point and the unreliable depth value point on the regular grid.

16. The method of claim 1, further comprising:
capturing the ToF image of a scene using an ToF sensor; and
capturing the left image and the right image of the scene using a color image sensor;

17. An electronic device comprising:
one or more processors configured to execute instructions; and
one or more memories storing the instructions,
wherein the execution of the instructions configures the one or more processors to:
calculate a first reliability of each of a plurality of time of flight (ToF) pixels of a ToF image;
generate, based on the first reliabilities, a depth map of a scene based on a left image a right image, and the ToF image; and
generate, based on the first reliabilities, the depth map based on the left image and the right image without consideration of the ToF image.

18. The electronic device of claim 17, wherein, for the calculating of the first reliabilities, the one or more processors are configured to:
project each of the plurality of ToF pixels of the ToF image onto the left image and the right image;
calculate a second reliability of a ToF pixel corresponding to each ToF projection point on a corresponding scan line in a first direction; and
calculate, based on the second reliability, the first reliability of a ToF pixel corresponding to each ToF projection point on another corresponding scan line in a second direction that is opposite to the first direction.

19. The electronic device of claim 17, wherein, for the generating of the depth map, the one or more processors are configured to:
determine a first quantity of first reliability ToF pixels, of the plurality of ToF pixels, that have respective first reliabilities that satisfy a predetermined requirement;
in response to the first quantity satisfying a first threshold requirement, perform the generation of the depth map based on the left image, the right image, and the ToF image; and
in response to the first quantity not satisfying the first threshold requirement, perform the generation of the depth map without consideration of the ToF image.

20. The electronic device of claim 19, wherein, for the performance of the generation of the depth map based on the ToF image, the one or more processors are configured to:
perform a first stereo matching of the left image and the right image;
predict, using a first neural network, another reliability of each of the plurality of ToF pixels based on the ToF image and a result of the first stereo matching;
perform a second stereo matching of the left image and the right image based on the ToF image and the other reliabilities; and
generate the depth map dependent on the performed second stereo matching.

21. The electronic device of claim 17, wherein, for the performance of the generation of the depth map without consideration of the ToF image, the one or more processors are configured to perform a third stereo matching of the left image and the right image, and generate the depth map dependent on the performed third stereo matching.

22. The electronic device of claim 17, further comprising:
a first sensor configured to capture the ToF image of a scene; and
a second sensor configured to capture the left image and the right image of the scene.
